(19) United States
(12) Patent Application Publication
(10) Pub. No.: US 2007/0061235 A1
(43) Pub. Date: Mar. 15, 2007

(54) System and method for pooling of investment assets

(76) Inventors: Mary E. Timmons, Chicago, IL (US); Deanna N. Belczak, Chicago, IL (US); Phillip D. Caldwell, London (GB); Kieran A. Hickey, London (GB); Thomas C. Lauer, Chicago, IL (US); Andrew M. Lewis, Essex (GB); Larry L. Rountree JR., Palos Heights, IL (US); Matthew C. Severs, Chicago, IL (US)

Correspondence Address: BRINKS HOFER GILSON & LIONE, P.O. BOX 10395, CHICAGO, IL, 60610, US

(21) Appl. No.: 11/508,471

(22) Filed: Aug. 23, 2006

Related U.S. Application Data
(60) Provisional application No. 60/712,455, filed on Aug. 30, 2005.
(60) Provisional application No. 60/713,281, filed on Aug. 31, 2005.

(51) Int. Cl. G06Q 40/00

(52) U.S. Cl. 705/36 R

(57) ABSTRACT

A system and method for pooling of investment funds enables a multinational corporation to cause its employee benefit plans from multiple international jurisdictions to pool their investments into a single entity, which invests in various financial products including exchange traded debt and equity securities as well as other securities. The entity is preferably structured as an offshore pooled vehicle, which may have one or more sub-funds that vary by investment objective and/or eligible investments. Each pooled vehicle is preferably organized as an Irish CCF, a Luxembourg FCP, a Dutch FGR or other tax-transparent vehicle. The investors in such pooled vehicles and sub-funds are preferably the employee benefit plans of the multinational corporation. A banking or trust organization that is duly qualified and licensed to act under the laws of the applicable jurisdiction as a management company for the pooled vehicles will act on behalf of the applicable pooled vehicle.

### RELATED APPLICATIONS

The present application claims priority, under 35 U.S.C. § 119, to provisional patent application Ser. Nos. 60/713,281, filed on Aug. 31, 2005, and 60/712,455, filed on Aug. 30, 2005, the contents of which are incorporated herein by reference.

### BACKGROUND OF THE INVENTION

Investment vehicles such as collective investment funds (domiciled in various countries), pension funds (including those subject to ERISA), trust funds, insurance company funds or other collective investment vehicles have certain operating costs. To name just a few expenses, every fund, including institutional funds, pays an investment advisory fee to an investment adviser who invests the fund's assets, custodian fees to a custodian for the safekeeping of the fund's assets, portfolio accounting fees for the determination of the fund's asset value and income, shareholder servicing fees to various entities which provide investors with information and services regarding the fund, an audit fee to the fund's independent accountants who review the fund's financial statements, and a legal fee for counsel to represent the fund and each of its independent trustees. A retail fund (one whose investors are largely individuals) incurs the same kinds of expenses as an institutional fund, although certain expenses, such as shareholder servicing fees and distribution (12b-1) fees, will be larger for a retail fund, since individual investors need more services than do sophisticated institutional investors.

Having a large amount of assets results in various economies of scale in fund operating costs. Since many of a fund's expenses are independent of the fund's asset base, a larger fund asset base produces a lower operating expense ratio (expenses to assets), which increases the net investment performance of the fund. Also, since larger funds purchase securities in larger denominations, they are able to bargain for higher yields (on bonds and other debt securities) or pay lower brokerage commissions (on equity securities) than a smaller fund can.

One way to achieve a large asset base is to combine assets of two or more funds. Current laws, however, place several restrictions on commingling the assets of separate funds. Attempts have been made to overcome this shortcoming. One known financial services configuration, called “Hub and Spoke” (Signature Financial Group, Inc.), does allow for commingling the assets of two or more funds. This financial services configuration involves a structure that is treated as a partnership for federal income tax purposes, and that holds the investment portfolio and funds that invest as partners in the partnership portfolio.

Under the partnership portfolio and partner fund configuration, each of several funds are called “Spokes.” In addition, a “partnership portfolio,” called the “Hub,” is established, and each fund is an investor in the partnership portfolio. The partnership portfolio is registered under the 1940 Act (since it is an investment company), but its shares are not registered under the 1933 Act. Individuals cannot invest directly in the partnership portfolio. Its only investors are the funds themselves, each of which is able to invest 100% of its assets in the partnership portfolio.

Although the partnership portfolio may legally be regarded as a trust or other entity, it is generally considered to be a partnership for U.S. tax purposes. As a partnership, it generally receives “flow-through” tax treatment and, so, for U.S. purposes, the partnership portfolio does not pay taxes, but rather all economic gain or loss flows through to the funds as partnership portfolio investors. U.S. mutual funds must rely on qualifying for “regulated investment company” (“RIC”) status under the Internal Revenue Code (the “Code”) to be exempt from taxation. The RIC provisions of the Code generally prevent mutual funds from investing in other types of investment funds and impede the division of a single mutual fund into multiple mutual funds. These RIC provisions also lead to economic distortions and inequities among shareholders which will be discussed below.

With the assets of two or more funds combined in the partnership portfolio, however, the economies of scale described above can be more fully realized. The assets of different types of funds may now be commingled, resulting in more efficient and effective investment management. While many funds can benefit from Hub and Spoke services, a fund with a small amount of assets, which ordinarily would not be a viable investment fund because it would have a prohibitively high operating expense ratio, can now be established on a cost-effective basis by investing its assets in a partnership portfolio. Investing in a partnership portfolio also provides the new fund with an investment history, which makes the fund more attractive to investors. Therefore, a fund sponsor can more efficiently organize a new fund to be offered to customer markets that previously could not be economically accessed by that sponsor.

Because the partnership portfolio is not a mutual fund, it is not subject to certain economic distortions and inequities that are inherent to normal mutual fund investing. Consider a first fund which invests in a second fund just before the second fund distributes its capital gains. The first fund realizes capital gains from this distribution, as does every shareholder of the second fund. The first fund, however, has not actually realized any gain in the value of the second fund, and so the second fund is merely returning a portion of the first fund's original investment. The first fund may be required to pay tax on this part of its original investment or, if the fund is a mutual fund, pass such tax on to its shareholders. Thus, a partial return of investment becomes subject to tax.

Unlike a mutual fund, the partnership portfolio makes daily allocations of income, capital gains, and expenses or investment losses, rather than actual distributions. These daily allocations, which are determined and managed by a data processing system, are based on an “allocation ratio.” Such daily allocations avoid economic distortions and inequities by directly allocating the appropriate economic benefit and loss to each shareholder on that day. Mutual funds merely distribute income, and gain or loss, to whatever shareholders happen to exist on an arbitrary date when a distribution is made. While such gain or loss is taken into account in between such distributions through the determination of the net asset value of the mutual fund's shares, it is the distribution of the gain or loss which creates a taxable gain or loss for a shareholder. The Hub and Spoke financial services configuration thus avoids this disadvantage by more accurately matching economic and taxable income.

The partnership portfolio and partner fund configuration presents great administrative challenges, however. Because each of the partners in the partnership portfolio is some type of fund, the assets of which change daily as customers make further investments or withdrawals, the partnership interest of each fund varies daily. For example, consider a partnership portfolio made up of Funds A and B. Assume that at the start of the day, Fund A has $750,000 invested in the partnership portfolio and Fund B has $250,000 invested. The partnership portfolio has $1,000,000 in assets with Fund A having a 75% share and Fund B having a 25% share. Next, assume that by the end of the day, the partnership portfolio has not changed in value due to market fluctuations, but that additional purchases by Fund shareholders have given Fund A $800,000 in assets and Fund B $275,000 in assets, and these assets are invested in the partnership portfolio. The partnership portfolio has grown to $1,075,000 in assets, with Fund A now having a 74.4% share and Fund B now having a 25.6% share of the partnership portfolio assets.

Further complexities arise as the value of the partnership portfolio assets rise and fall or as additional funds invest in the partnership portfolio (or as existing funds withdraw their investments entirely). Additionally, as in any mutual fund complex, many Hub and Spoke structures may be administered simultaneously. A sophisticated data processing system is necessary to enable accurate daily allocations to be made among each of the funds in a partnership portfolio. Also, each such daily allocation is comprised of various economic components—income, gain, loss, expenses. These various components must be isolated and aggregated, on a continual basis, for both non-tax accounting purposes and, again (in separate accounts), for tax purposes.

Economic inaccuracies would appear over time if daily allocations were not made. Such inaccuracies will arise since typically a mutual fund will not actually allocate or pay out on a daily basis the economic components of the fund's economic experience for that day. Depending on a particular fund's prospectus, actual cash distributions can be made monthly, quarterly, or as otherwise so determined.

Were the partnership portfolio structured as a mutual fund, which makes distributions on a periodic basis, income earned on a given day, if not allocated on that day, would result in an increase in capital value of the fund as a whole, rather than in income received by a particular investor; similarly, expenses incurred, if not allocated on that day, would result in a decrease in capital value of the fund as a whole, rather than as a decrease in income for a particular investor. What is needed is a data processing system that allows each fund to recognize on its balance sheet its fair share of economic benefit or loss experienced by the portfolio on that day.

In addition, each fund has a book capital account, which represents each fund's total investment in the partnership portfolio including all earned, but undistributed, economic benefit. This book capital account for each fund includes the previous day's fund shareholder purchases and redemptions, the fund's proportional share of daily portfolio income and expenses, and the fund's share of daily portfolio realized and unrealized gain or loss. What is lacking, however, is a fund portfolio that retains 100% of all of the investment assets within the fund itself, without establishing a partner fund configuration, and can take advantage of certain cross-border tax treaties to provide the above advantages of the Hub and Spoke system without the resultant tax consequences. Such a system would allow multinational companies or investment management companies, for example, to pool pension fund or other fund assets around the world, consolidate these funds in a tax-transparent environment, and under a single or multiple number of investment managers, and invest those pooled assets in multiple jurisdictions around the globe.

Companies and investment promoters are anxious to centralize the administration and management of their collective investment structures (CIS), for reasons of efficiency and cost. The globalization of markets, which has been encouraged by international conventions and treaties, is actually causing promoters to search for the ideal product that is able to accommodate all markets and countries. In practice, the promoter in the field is unfortunately frequently compelled to adapt what should be a single product to different markets or consumers or sales networks. The object is first and foremost to meet a marketing objective. There is a need to meet the expectations and requirements of consumers as closely as possible and also to prevent detrimental effects with regard to tax. The problem is that investment promoters have to set up a number of different entities, vehicles and structures.

This means that investment promoters are facing a dilemma. On the one hand, the considerations of efficiency and cost described above encourage them to adopt a single structure. On the other hand, the market is subject to forces which are mainly the result of commercial objectives and which encourage promoters to create a multiplicity of structures. In order to resolve this dilemma, promoters need to be permitted to globalize the administration and management of all the entities, which market forces compel them to create.

Known globalization methods such as described above are based on the pooling of their assets of one form or another so that they can be subjected to global management and administration. Such pooling is made possible by the creation of a joint portfolio. Another known technique takes a different path and provides for a global data processing system for distributing assets between different portfolios belonging to one or more funds or other entities which may or may not be legal persons and which are able to hold, own or collect assets and which may themselves be the object of an individual management and/or administration measure.

The above-described technique is based on a principle known as “cloning.” This term applies to the cloning of internal portfolios belonging to one or more entities as defined above which, in the most successful configuration, makes it possible to create identical twin portfolios or entities. In such a configuration, the cloned internal portfolios for each participating entity are not mutually linked by any kind of contract, but they do enter into mutual contracts with the same parties. In particular, they can have the same depositary and the same administrative agent. A manager or administrative agent may take the form of a person, an organization or an entity, which is tasked with managing and/or administering a specific portfolio comprised of assets of the various participating entities.

Unlike known globalization methods, cloning typically does not require any legal link between the cloned entities (independent and total control over assets) or the creation of any kind of common external portfolio as a separate legal unity or investment vehicle. This makes full and permanent separation of the assets possible. This permanent separation of the assets of participating entities results in a relatively high degree of financial independence and full legal independence between the participating entities.

Such a configuration of clonable entities typically requires an information processing system that is designed to determine and control distribution of the assets of the various cloned portfolios of the participating entities on a commingled basis. This processing system provides an information system based on data representing the assets of the various cloned portfolios. This information processing system should also give a global asset manager access to a large information system, including a consolidated management report, which enables the manager to take decisions on a commingled basis. It readjusts the internal cloned portfolios after any specific transaction involving one or more cloned internal portfolios in such a way that they are equivalent on a relative basis. The internal portfolios are readjusted via a processing procedure. Such a system processes cash flow from operations (subscriptions, redemptions, conversions) occurring at the level of each cloned entity. In principle, any one of such operations causes one or more cloned entities to have a larger or smaller proportion of assets held in cash than the others. Such a processing system readjusts the internal portfolios by generating purchases for cloned entities having a relative surplus of cash assets and sales for cloned entities having a relative deficit of cash assets. These technical transactions of purchases and sales are generated automatically by the information system, and the processing is carried out in stages.

What is lacking is a system and method that combines the benefits of both of the above-described configurations, but without the detriments. Namely, In the case of cloning: (a) security is based in the mutual contracts only; (b) regulatory supervisory oversight over the commingled portfolio is absent; and (c) control is decentralized. A configuration that would overcome these constraints would be a legal vehicle, for example an off-shore (non-U.S.) vehicle, that is established as the owner of financial assets, but which nevertheless is regarded as a look-through vehicle for U.S. and international tax purposes, thus enabling investors to take advantage of double taxation treaty entitlements. In addition, a sophisticated data processing system is required to support such a structure and to report distributed and rebalanced portfolios within the structure, thus ensuring each investor in the structure a proportionate share of, or ownership interest in, each asset of the portfolio or portfolios within the structure. Like the Hub and Spoke system described above, the commingled portfolio is a legal vehicle, which is different from the cloned configuration described above in which no legal vehicle exists. Unlike the Hub and Spoke system, investors (which may be funds or institutional investors) may invest directly in the commingled vehicle and no partnership fund configuration is required. A sophisticated methodology is then required to maintain identical portfolios for each investor on a relative proportion basis.

### BRIEF SUMMARY OF THE INVENTION

In view of the above, there is provided, in one aspect of the invention, a fund management system for providing tax transparency to separate investors across country boundaries. The fund management system includes a managed fund for owning at least one security, and at least one account (a subset of the managed fund) reflecting the asset ownership proportions in the managed fund, the at least one account not having legal ownership of any independent financial assets, but owning a percentage share in assets of the managed fund. The managed fund is also open to investment by a plurality of investors who can purchase a percentage ownership in the managed fund. The system further includes means for maintaining a relative percentage ownership of each of the plurality of investors in response to changes in the at least one security in the managed fund.

According to another aspect of the invention, a method is provided for managing an investment fund to provide tax transparency to separate investors across country boundaries. The method includes owning at least one security in a managed fund, providing another account that reflects the investor's proportionate percentage of holdings and transactions in the managed fund; opening the managed fund to investment by a plurality of investors who can purchase a percentage ownership in the managed fund; and maintaining a relative percentage ownership of each of the plurality of investors in response to changes in the at least one security in the managed fund.

In another aspect of the invention, a data processing system is provided for managing a financial services configuration of a portfolio established as a pool of assets with investors subject to different withholding tax rates. The system includes a managed fund that has legal ownership of all assets within the fund, and at least one account that does not have legal ownership of any independent financial assets but rather reflects a share of ownership in all the assets. The system also includes means for reporting of distributed and rebalanced funds to ensure that the at least one account maintains a proportionate share of assets within the managed fund.

In yet another aspect of the invention, a method for managing a financial services configuration of a portfolio established as a pool of funds is provided. The method includes providing a managed fund that has legal ownership of all assets within the fund; forming at least one account, which does not have legal ownership of any independent financial assets, but rather reflects a share of ownership in all the assets; and ensuring that the at least one account reflects a proportionate share of assets within the managed fund.

The present invention thus enables a multinational corporation to cause its employee benefit plans from multiple international jurisdictions to pool their investments into a single entity, which would invest in various financial products including but not limited to exchange traded debt and equity securities as well as various non-exchange traded transactions, including investments in swaps, over-the-counter options, futures, limited partnerships, unregistered notes or master note programs, unit trusts and certain commingled funds. In other instances, investment managers may establish tax-transparent vehicles to attract investors (including pension funds, charities, insurance companies, corporations and fund vehicles) from different parts of the world.

The invention is preferably structured as a pooled vehicle that may have one or more sub-funds that vary by investment objective and/or eligible investments. In the preferred embodiment, each pooled vehicle may be organized as an Irish CCF, a Luxembourg FCP, or a Dutch FGR. Alternatively, pooling funds can be established and supported in other jurisdictions where the legal and regulatory environment is conducive to the establishment of such a pooling fund. The investors in such pooled vehicles and sub-funds may be employee benefit plans of the multinational corporation, charities, insurance companies, or other investor types. A banking or trust organization that is duly qualified and licensed to act under the laws of the applicable jurisdiction as a management company for the pooled vehicles will act on behalf of the applicable pooled vehicle.

These and other features and advantages of the invention will become apparent to those skilled in the art upon a review of the following detailed description of the presently preferred embodiments of the invention taken in conjunction with the appended drawings.

### BRIEF DESCRIPTION OF THE DRAWINGS

FIG. 1 is a block diagram showing different investment pooling structures, where FIG. 1A shows a prior art cloned pooling structure, and FIG. 1B shows the asset pooling structure of the invention;

FIG. 2 is presently preferred multi-level diagram showing the investment pooling account structure of the invention;

FIG. 3 is a chart illustrating the processes executed by the investment pooling system on a daily basis;

FIG. 4 is a timeline showing the presently preferred semi-monthly valuation and dealing cycles of the invention;

FIG. 5 is a chart showing one example of the trade splitting process of the invention;

FIG. 6 is a chart showing one example of the rebalancing process of the invention;

FIG. 7 is a chart illustrating the pooling reconciliation process of the invention;

FIG. 8 is an expanded chart of the reconciliation process shown in FIG. 7;

FIG. 9 is a chart illustrating the income reconciliation process of the invention;

FIG. 10 is a block diagram of the technology system infrastructure of the invention; and

FIG. 11 is a flow chart showing the flow of the fund accounting process of the invention.

### DETAILED DESCRIPTION OF THE PRESENTLY PREFERRED EMBODIMENTS OF THE INVENTION

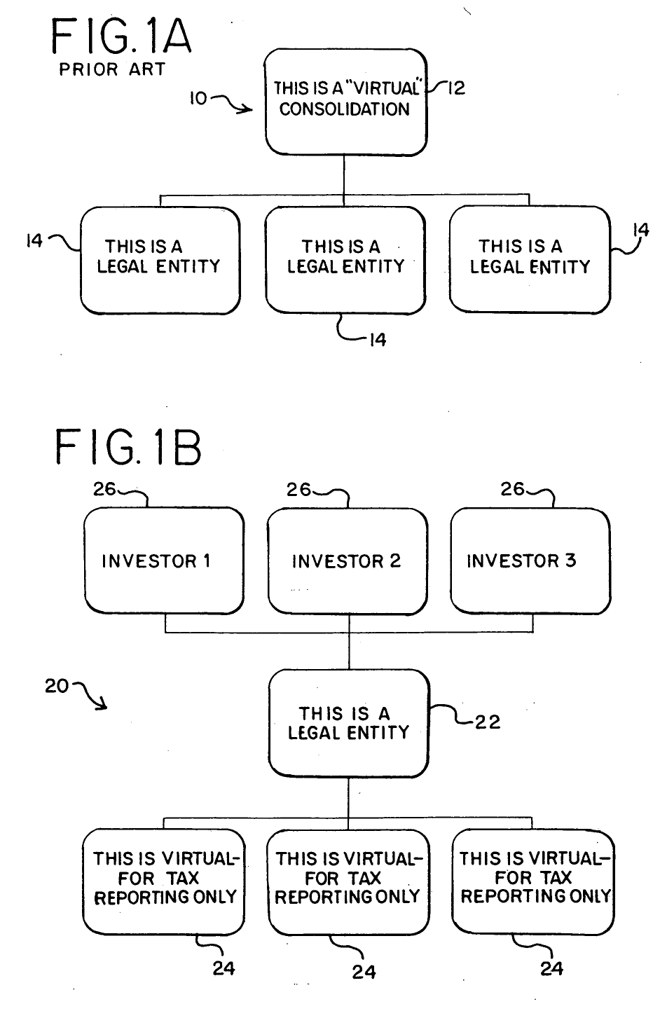

Referring now to the drawings, where like reference numerals refer to like elements throughout, a pooling block diagram is shown in FIG. 1. The structures shown in FIG. 1 are for asset pooling. In FIG. 1A, a prior art cloned/pooling structure 10 is shown. According to the prior art cloned/pooling structure 10, a virtual consolidation 12 exists at the upper level of a two-level hierarchy, and one or more legal entities 14 are participants in the “virtual” consolidation 12. In the prior art structure, ownership of securities remains in the legal entities 14. The “virtual” consolidation 12 reflects the commingling of the assets of the three separate legal entities 14. The “virtual” consolidation 12 is therefore a clone of these entities 14. Securities are not owned at the upper level. Rather, the cloning system readjusts the ownership of securities by the legal entities 14 by taking into account changes in ownership as a result of subscriptions or redemptions, etc., into or from the legal entities 14. The cloning system thus ensures that the ownership ratios of the legal entities 14 remain accurate before and after these account changes.

In contrast to FIG. 1A, the asset pooling structure shown in FIG. 1B illustrates a different pooling structure 20, where legal ownership of all securities exists in one legal entity 22 at the middle level. But beneficial ownership of the assets vests in the investors, as tenants in common. Thus, unlike the cloning structure described in FIG. 1A, where the participants 14 continue to own the assets, in FIG. 1B the investors 26 own a percentage ownership interest in all of the commingled assets. In one presently preferred embodiment, offshore investment vehicles comprise the legal entity 22 in order to retain tax transparency. According to the preferred system and method, a sophisticated methodology is provided to reflect (a) legal ownership and beneficial ownership interests, and (b) to report the distribution and rebalancing of ownership interests to ensure that each investor maintains an accurate proportion of ownership interest in each security held in the legal entity 22 at all times.

According to the presently preferred embodiments of the invention, two types of investment pooling are supported in the structure shown in FIG. 1B. The first is multinational pooling, and the second is investment manager pooling. Multinational pooling is a single investment vehicle for multinational companies to pool investments such as pension assets from multiple country plans (e.g., where Swiss, Dutch and UK subsidiaries of a multinational company have their own country-based pension plans). Multinational pooling offers the following advantages to the multinational company: lower costs, enhanced governance and oversight from the corporate center, improved long term returns for the multinational sponsoring the defined benefit arrangements, and lower contributions. Thus, multinational pooling allows a pension sponsor, for example, to pool assets together across various countries, i.e., across various national tax treaties. While the assets are pooled for investment reasons, pension plan investors can still take advantage of double-taxation treaties. As a result, a pension plan may be subject to a different tax treaty—between UK and France, for example—depending on the country in which it is domiciled. (As background, a pension plan may be able to take advantage of tax concessions not available to a foundation, endowment or an individual. Further, an endowment may be a United States endowment, a United Kingdom charity, or an equivalent plan.)

Investment manager pooling, on the other hand, is the creation of a single pooling vehicle for various clients of the investment manager (“IM”) who may share similar or differing tax treatments (e.g. UK Pension Fund, UK Investment Fund, Dutch Pension Fund). In such cases, the IM manages a single portfolio for multiple clients, yet permits the investors to take advantage of double taxation treaties that apply to them and are not commonly available to investors in other types of pooled vehicles. Although the discussion below is primarily directed to multinational pooling, those skilled in the art will appreciate that the same features and advantages also can be applied to investment manager pooling as well without departing from the essential spirit and scope of the invention.

In the multinational pooling environment, in addition to lower costs of operation, a company can enjoy enhanced governance and risk management of pension assets. Whether it is a UK pension plan, an Irish pension plan or a Dutch pension plan, the company can focus more attention and expertise on oversight and monitoring of the consolidated assets. Moreover, the pension plans can achieve enhanced, more consistent performance. The multinational company thus gets economies of scale by pooling its assets together. Because the pooling vehicle is tax-transparent, the investors pay withholding tax as if they had invested directly in the market, so they're not any worse or better off from a tax perspective.

For investment manager pooling, on the other hand, if the investment manager manages 15 separately managed U.S. equity accounts, the structure shown in FIG. 1B would allow the manager to manage one fund and simultaneously serve all of the different investors at one time, while at the same time recording the proportionate ownership interest of each investor in the assets of the fund. Investors will not experience tax drag from participation in this type of vehicle.

According to the presently preferred embodiment, currently three types of pooling vehicles can be utilized in the pooling structure shown in FIG. 1B—one in Ireland, one in Luxembourg, and the third in the Netherlands. The Irish vehicle is called the Common Contractual Fund (“CCF”), the Luxembourg fund is called the Fonds Commun de Placement (“FCP”), and the Dutch vehicle is called the Fonds voor Gemene Rekening (“FGR”). Preferably, pooling vehicles like the CCF, FCP, and FGR are used in the investment structure shown in FIG. 1B to provide the tax advantages of the present invention. Although the presently preferred embodiments of the invention will focus on these three investment vehicles, those skilled in the art will appreciate that the invention will work with any country that allows for the creation of pooling vehicles with materially similar characteristics (whether or not investors or pooling vehicle sponsors require the benefits of tax transparency).

The essential feature of the system is the ability to create a full record of an investor's proportional interest (both holdings and transactions) in a pooling vehicle. (Those skilled in the art will appreciate that, although the presently preferred embodiment of the invention is directed to using a pooling vehicle for tax transparency, the invention can be employed for other purposes without departing from its essential spirit or scope.) The tax-transparent nature of the FCP, the CCF, and the FGR allows one to look through the vehicle itself to the appropriate investor, and look at their applicable tax treaty, and report relevant taxable events to the appropriate tax authority. Based on where the investor lives or is domiciled, different investors will have different tax implications. Within the structure shown in FIG. 1B, therefore, investors subject to different tax treatment can now invest in the same fund regardless of their tax disparities.

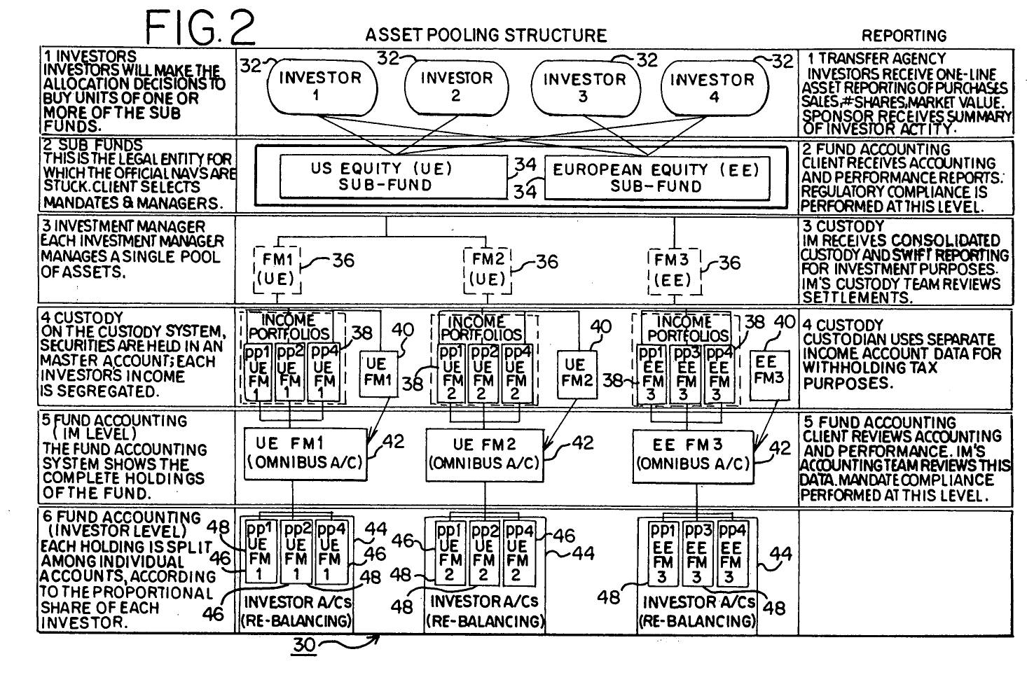

Referring now to FIG. 2, one presently preferred asset pooling structure 30 is shown. In the preferred embodiment, this structure 30 is represented as a multi-level diagram and investors 32 could invest in any of the funds 34. In general, various financial products including, but not limited to, exchange traded debt and equity securities can be employed, as well as various non-exchange traded transactions, including investments in swaps, over-the-counter options, futures, limited partnerships, unregistered notes or master note programs, unit trusts and certain commingled funds.

At level 1, a fund management system (described in further detail below) acts as a transfer agent (“TA”) to keep track of and manage the investor's records. The identity of the investors 32 will be maintained on the transfer agency's computer systems. In the preferred embodiment shown in FIG. 2, the pooling fund is established in either the Netherlands, Luxembourg or Ireland. Alternatively, pooling funds can be established and supported in other jurisdictions where the legal and regulatory environment is conducive to the establishment of such a pooling fund. The transfer agent records the units that represent ownership interest in the underlying securities.

The second level shown in FIG. 2 identifies the sub-funds within the legal entity 34 that constitute the legal owners of the securities mentioned in connection with FIG. 1B above. Depending on investment makeups, each sponsor of a pooling fund can decide what investment mandates they're interested in and create sub-funds accordingly. In this example, a U.S. equity and a European equity sub-fund 34 are shown in FIG. 2. These are by way of example only. Sponsors of a pooling fund may choose to have only one asset class and, therefore, there would be no need to create separate sub-funds 34. Those two sub-funds 34 represent the specific investment mandate set up by a sponsor of the legal entity. The investors 32 at level 1 make a decision whether or not to invest their money or other assets (by way of an in specie investment into the sub-funds 34) in one of the two sub-funds 34. In other words, they have the asset allocation decision to decide whether to invest in the U.S. or European equity funds. In the preferred embodiment, these investors 32 are institutions such as pension funds or investment funds.

The third level down in the structure shown in FIG. 2 is the investment manager level. At the investment manager level, a company can decide how many managers 36 to employ to manage the investments that were consolidated into the various sub-funds 34. The investment manager 36 is appointed as agent to manage the assets of the relevant sub-fund 34 and therefore functions like a mutual fund portfolio manager would function. The investment manager does not own the assets of the sub-fund 34. The sponsor of a pooling fund may choose to appoint one or more investment managers 36 for a given sub-fund 34. A sponsor may also decide the allocation of assets in a sub-fund 34 given to the appointed investment managers 36 for that sub-fund 34. So as shown in FIG. 2, “FM1” and “FM2,” etc., represent investment manager 1 and investment manager 2 for a particular sub-fund 34. The system preferably provides each investment manager 36 with consolidated custody and reporting for investment purposes.

Underneath each investment manager in FIG. 2, at level 4, is the custody system. The custody system (labeled “UEFM1,” “UEFM2,” etc.) represents the assets of each sub-fund 34 that are allocated to each manager 36. To the left, the three smaller boxes 38, labeled “PP1,” “PP2” and “PP4,” are the income portfolios that are separated from the capital or master account 40 invested in these accounts. Each income account 38 is tied to a single investor 32 who is potentially subject to a separate tax treaty depending on their domicile and/or tax status. Investor 2, for instance, could be a Dutch pension plan. The income portfolio will reflect the gross income that would have been credited to the account in respect to the Dutch plan's holdings for that period and is subject to the appropriate tax treaty. So for each investor 32 in each fund, the system breaks out the income for that investor to keep it separate for tax purposes as the tax treatment may be different based on investor domicile and tax status.

The fund accounting takes place at levels 5 and 6. The custody level (level 4) keeps all the records and reconciliations of all the depositories of sub-custodians throughout the global markets. At that level, the system records the settlement, receipt and delivery of cash and securities purchases and sales. The omnibus accounting level (level 5) reflects the net asset value of the sub-fund, and therefore reflects both settled and pending transactions (“Holdings”). The investor accounting level (level 6) reflects the proportionate net asset value per investor, and their proportionate settled and pending transactions (“Holdings”). No physical cash or assets actually move at levels 5 and 6. So the actual accounts exist only at the custody level (level 4).

The fund accounting system (levels 5 and 6) consolidates the income and capital accounts reflected on the custody system (level 4). Level 5 reflects each investment manager's aggregate Holdings. So, referring to FIG. 2, omnibus accounts 42 labeled “UEFM1,” etc. (level 5) represent all four boxes 38, 40 (shown in level 4) on a consolidated basis. Level 6 reflects all assets, income and transactions apportioned among individual investors, as well as transactions between investors. The system applies the tax rate appropriate to each individual investor account 46 at level 6 providing accurate income accounting. The purpose of level 4 is to apply the correct tax rate in respect to the income of each investor, providing accurate income collection and tax withholding. The purpose of level 6 is to create a complete accounting record for each investor and to accurately reflect capital gains and ownership participation.

As a result, a net asset value (“NAV”) per unit can be calculated or “struck” at level 6 for the aggregate of each investor's (share class') accounts 48 per sub-fund. In order to create the set of books for the sub-fund, all account changes are consolidated at level 5, and reconciled back to a custody account.

Additionally, level 6 is necessary because certain tax authorities need a report of realized gain/losses that were not effected based on market trades. For example, when subscriptions or redemptions come in through level 1, the ownership percentages in a particular security within a sub-fund may change. The system needs to reflect these changes in ownership percentages. So within each one of these boxes 46, as the new percentages are applied, the system rebalances each one of those three boxes 46. Thus, the three boxes 46 in level 6 equal in total the four boxes 38, 40 in total at level 4. The proportionate assets are broken out by investor at level 6 along with their unique income.

Subscriptions and redemptions are allocated to the investment managers 36 (e.g., UEFM1) and are reflected in the custody portfolio 40. Although for most investors subscription and redemptions are not taxable events per se, they do impact percentage ownership and result in a need to rebalance assets (described in detail below). According to the invention, the fund management system tracks all subscriptions, redemptions, and investor specific cash movements in order to maintain accurate ownership interests within the sub-funds 34. As income is received by each investor based on their relevant tax treaty, the percentage ownership is updated. This may happen as frequently as daily. So at level 6, the investor accounts 46 will include realized gain/losses that are not the result of market trades, but are due instead to rebalancing of percentages to ensure that ownership interests reflect the same proportions as the sub-funds 34. Level 6 is necessary because certain tax authorities require that these adjustments need to be reported. Level 6 reflects a notional ownership of assets based on each investor's percentage ownership interest in the assets of a sub-fund as a tenant in common.

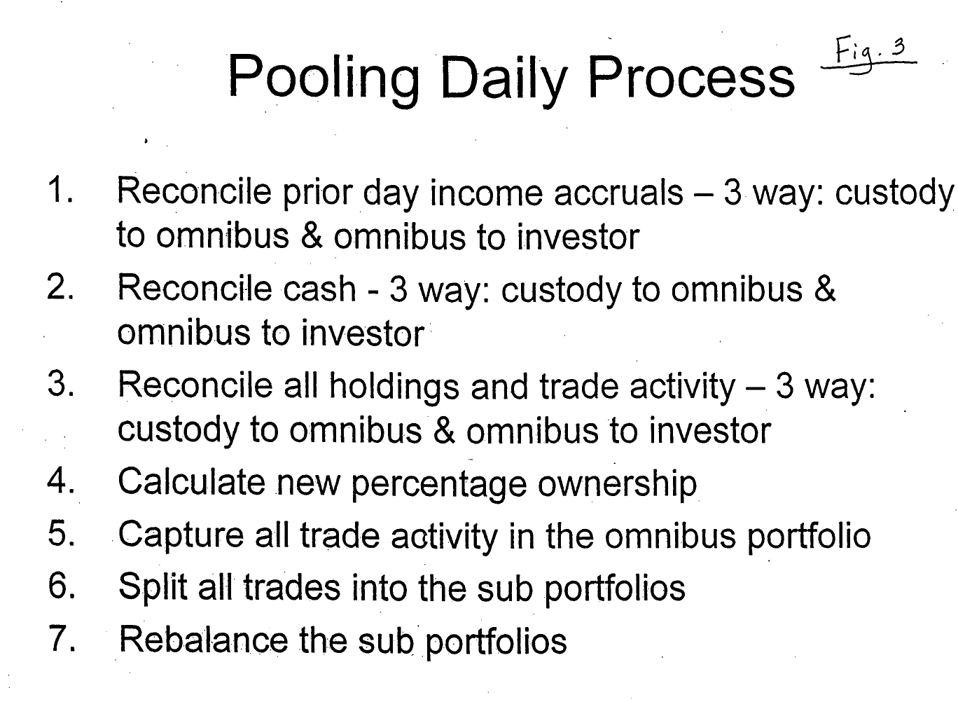

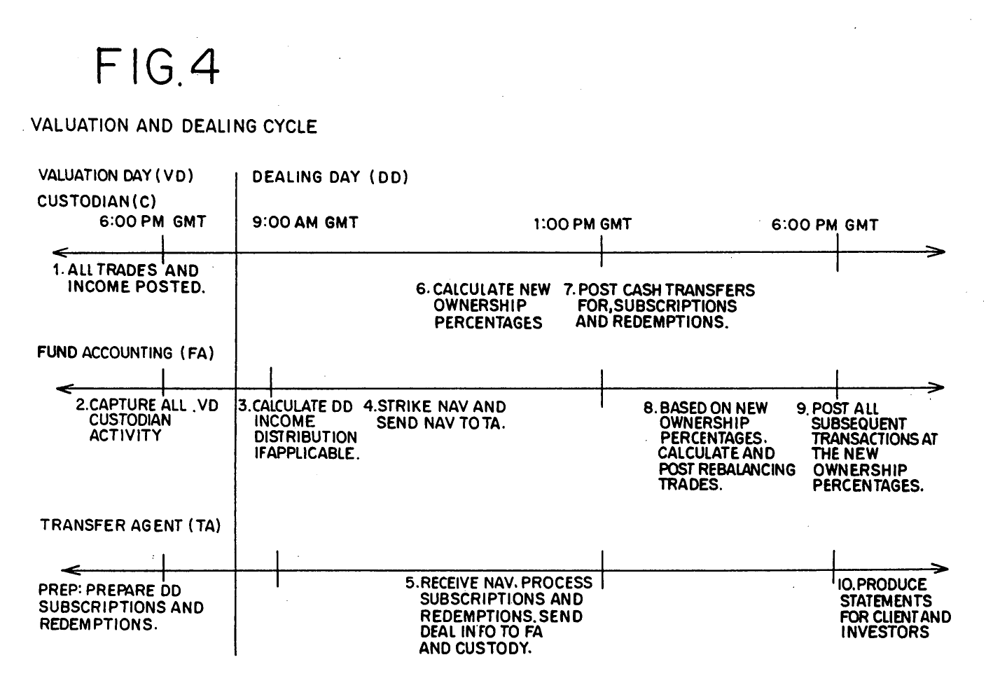

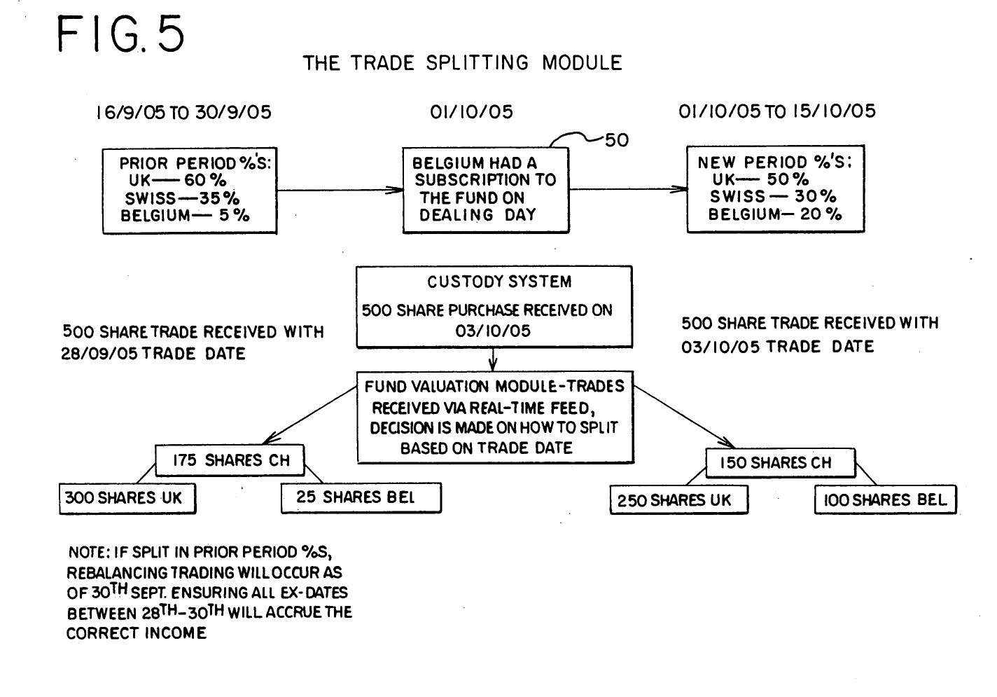

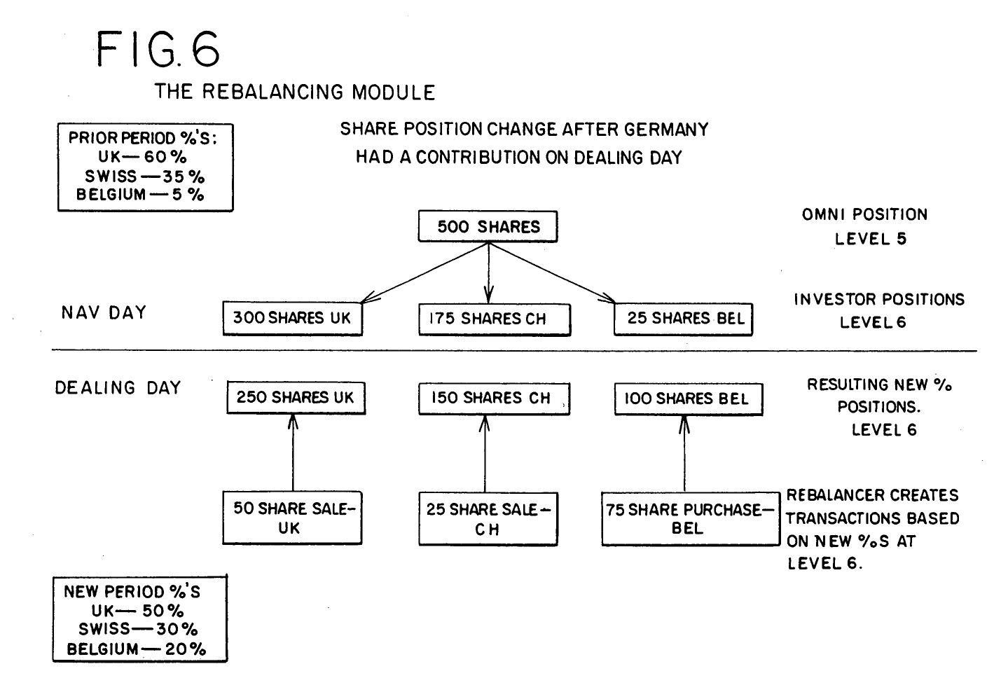

The four main processes performed by the fund management system to implement the structures shown in FIGS. 1B and 2 are described in further detail in connection with FIGS. 3-9. In FIG. 3, the daily process flow is shown to illustrate what steps are performed on a day-to-day basis. The semi-monthly valuation and dealing cycles according to the preferred embodiment are depicted in FIG. 4. As those skilled in the art will appreciate, however, both greater and lesser cycles (e.g., monthly, weekly and daily valuations) can also be performed without departing from the spirit and scope of the invention. The transaction splitter and rebalancing details of the invention are shown in FIGS. 5-6.

Pooling Daily Process

FIG. 3 illustrates the daily process, e.g., what's done on a daily basis within the fund management system for cross-border pooling of funds. On a daily basis, the system captures all activity between level 4 and level 5, it reconciles all the positions between levels 4 and level 5, then splits the incoming trades into the various level 6 accounts based on ownership percentage. And then rebalancing is again performed if needed. In addition to shareholder activity, income received and fees paid may change ownership percentages as frequently as daily resulting in rebalancing transactions.

Pooling Valuation and Dealing Cycles

Referring now to FIG. 4, a timeline of the preferred semi-monthly valuation and dealing is depicted. Three timelines represent the activity that takes place in the custodian, accounting, and transfer agent systems and processing groups.

Using the semi-monthly example, a NAV day and dealing day occurs twice every month. The net asset value (“NAV”) is calculated in a manner generally known in the art and need not be described in further detail herein. This cross-border pooling NAV is no different from any other fund NAV process, and in the presently preferred embodiment uses the same computer software and system, using the same process and the same audit checks as is universally done. The only thing that's different is that the system strikes a NAV for each investor or share class of the fund. Each investor's (share class') NAV varies due to their unique income earned (due to differing tax rates and fees or charges per share class). After the NAV is calculated, the NAV is reported back to the Transfer Agent at level 1.

Alternatively, income can be distributed prior to each NAV, allowing all investors within the same fund to receive the same capital NAV. In this scenario, both the NAV and income distribution is reported back to the Transfer Agent at level 1. The system therefore can perform either share class or capital NAVs within the context of the invention. Ultimately, the system can distribute income as needed. Once all the shareholder activity is captured, which includes decisions to reinvest realized income, the income will become automatically reinvested as a subscription, so it comes back in as capital. Thus, only after all the subscription and redemption activity comes in can the new percentages be determined, and that's when, at level 6, the rebalancing to the new percentages is performed.

Transaction Splitter Details

FIG. 5 shows the operation of one presently preferred trade-splitting module. Trade splitting is the mechanism that works in tandem with the rebalancing module to ensure the assets remain proportionate to the percentage ownership before and after account changes take place. In the example shown in FIG. 5, the 16^{th} of September to the 30^{th} of September, is a dealing period, and the UK, Swiss, and Belgian accounts represent three different investors located in three different countries. In the example shown, the Belgian investor had a subscription that occurred on the first of October (box 50). As a result, the new ownership percentages for the next two-week period are adjusted from 60-35-5 to 50-30-20 for the UK, Swiss, and Belgian investors, respectively. In this simplified example, assume that the custody system only had one trade for 500 shares of stock in this period. The trade, is effected by the investment manager 36 of a particular sub-fund 34.

The system then captures the trade into custody on the 3rd of October (i.e., the next day). However, referring back to FIG. 5, the system is going to use the 28^{th} of September for splitting purposes because that was the trade date of the trade. In that case, the system will use the original 60-35-5 percentages to split the trade because the trade is treated as occurring before October 1. This is necessary because, should the security go ex-dividend, let's say on the 29^{th} of September, the investors should receive their dividend based on their percentage ownership as of the ex-date. So the system splits back to the trade date. If the trade actually occurred on the 2^{nd} of October, as shown on the right side of FIG. 5, the same as the date that the system captured it, it would split to the new allocation percentages (e.g., 50-30-20).

In the presently preferred embodiment, the trade splitter is proprietary software which has been integrated into software purchased from SunGard Data Systems Inc., www.sungard.com, and sold under the trade name Global Invest One (“GIO”). The trade splitter module operates between level 5 and level 6. It uses percentage ownership information in conjunction with the level 5 transactions to calculate the split transactions that are posted to level 6, shown in FIG. 2. Trades are split to the smallest nominal upon which income can be collected from the paying agent on behalf of the beneficial owner.

Rebalancing Details Referring now to FIG. 6, a chart showing the rebalancing process, which is performed in conjunction with the trade splitting module shown in FIG. 5, is provided. In the example shown in FIG. 6, the same country, same investors, and same percentages shown in FIG. 5 are used for ease of reference. Coming into the dealing day, or NAV day, notional share ownership is reflected at 300,175, and 25 shares, between the UK, Swiss, and Belgian accounts, as shown in FIG. 5. On dealing day, because there are new ownership percentages, the system needs to reflect a new notional ownership of 250, 150, and 100 shares, respectively, for each of the three investors because Belgium funded a subscription (see above). In the example given, assume that no other investor made any purchases or redemptions. In order to accomplish the rebalancing, which occurs at level 6 in FIG. 2, and is reflected in the last three boxes 44 at the bottom of FIG. 6, the UK and Swiss investors both need to sell ownership interests in shares (reflected as a sale of a notional 50 and 25 shares, respectively) to Belgium so that all three investors end up with the correct ownership percentages both before and after the Belgian subscription. These additions or subtractions are automatically performed by the rebalancing process to reflect the new subscription so that all three investors hold the proper ownership percentages in the shares. This process is performed as often as daily. Realized gain/losses are accounted at level 6, and can also be reported. Rebalancing is completed to the smallest nominal upon which income can be collected from the paying agent on behalf of the beneficial owner.

Reconciliations

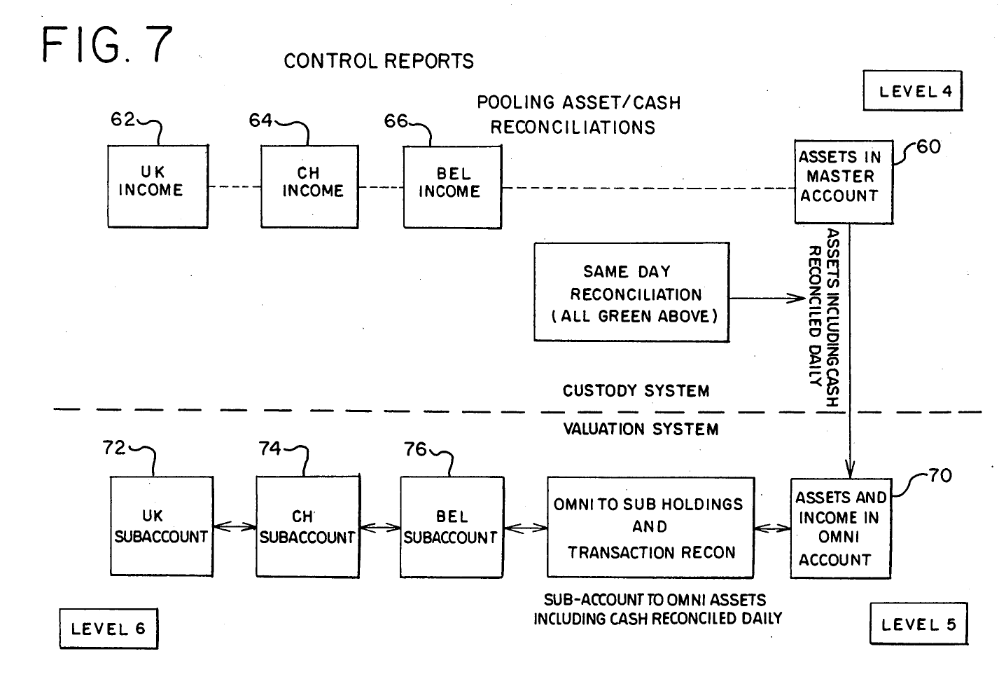

FIG. 7 shows a flow chart for pooling reconciliation activities according to the preferred cross-border pooling system and method of the invention. The majority of reports used in the pooling environment are standard and the same as reports generated for fund accounting purposes generally known in the art. Enhanced custody to valuation system reconciliations have been provided, however, to accommodate the needs of the pooling system and process. Further, control reports have been generated for the transaction splitter module illustrated in FIG. 5 and rebalanced transactions shown in FIG. 6.

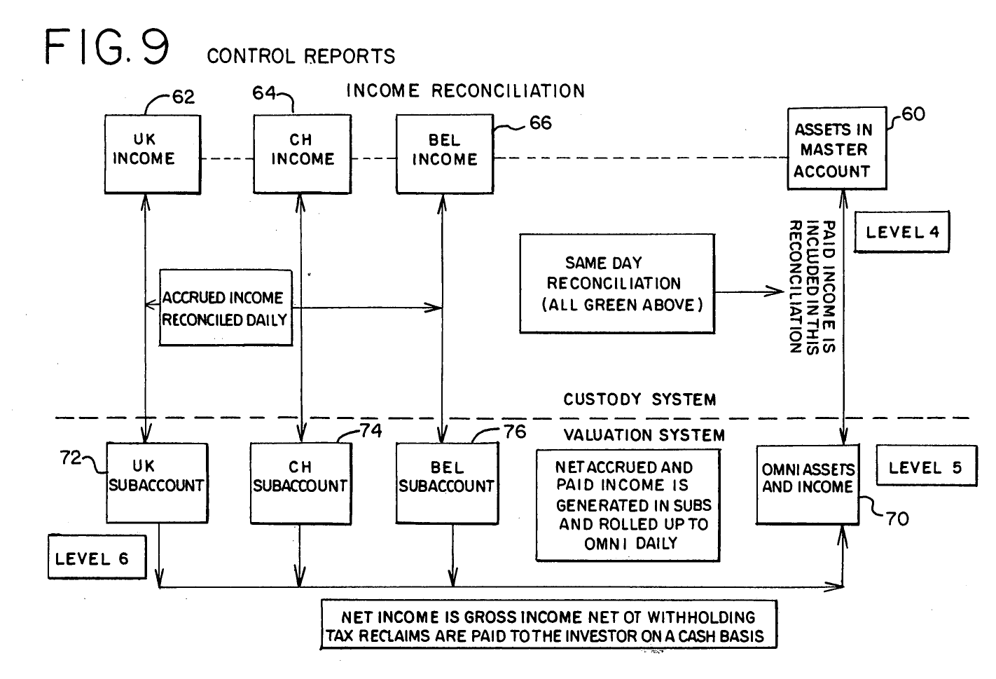

As shown in FIG. 7 at the top of the drawing, this flow-chart shows how to reconcile between levels 4, 5, and 6. Level 4 (upper half of FIG. 7) is reconciled daily to level 5 (lower right) for holdings, cash, and transactions. Assets in the master account 60 plus UK income 62, Swiss income 64, and Belgian income 66 reconcile to omni account 70. Level 5 to level 6 (lower left) reconciliation is performed in the same manner; holdings, cash, and transactions are reconciled. Omni account 70 is reconciled daily to the UK sub-account 72, Swiss sub-account 74, and Belgian sub-account 76. In FIG. 9, an additional process of income reconciliation only shows reconciled accrued income and paid income, which is also performed daily because of the importance of income capture to pooling and taxes.

Reconciliation across the dashed line in FIG. 7 shows communication between the preferred GIO software described above and used in the valuation process, and the presently preferred Fundmaster software used by the custody system at the assignee, Northern Trust Bank, located in Chicago, Ill. The transaction splitter function occurs at level 6 but is based on transactions occurring at level 5, and the rebalancing function occurs at level 6.

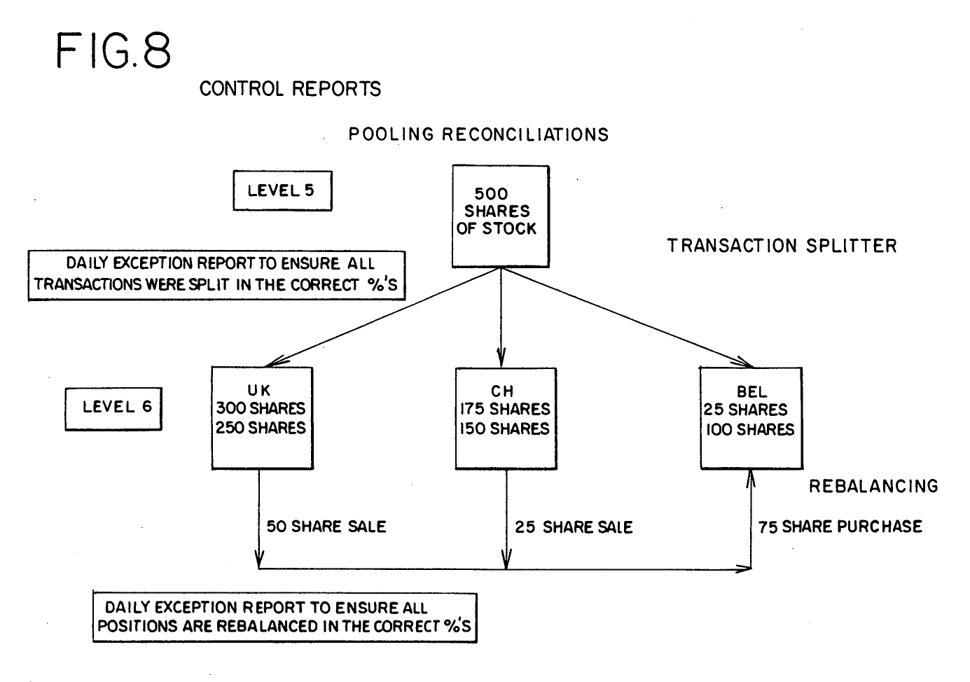

FIG. 8 is an expanded chart showing the transaction splitting and rebalancing software functions built into the system. The system identifies any split transactions that were not based on the correct percentage ownership and any holdings that are not in line with the correct percentage ownership. The system also identifies if the nominals and cash from the related split transactions do not equal the original transaction. For rebalancing transactions, the system ensures all transactions are equal and offsetting. The same exemplary data used in FIGS. 5 and 6 are provided for ease and consistency.

As illustrated in FIGS. 7 and 9, the system performs three-way reconciliations to make sure that at any point in time, levels 4, 5, and 6 remain in balance. As a result, the fund management system of the invention will know if any trades split or any position is not rebalanced into the correct percentages. If for any reason the accounts are out of percentage, a notification is preferably provided.

In relation to the above discussion, the terms NAV Day, Dealing Day, and Dealing Period are defined below in Table 1 and apply according to the presently preferred embodiment of the invention.

Fund accounting in the preferred embodiment is performed in the back office of a banking institution. The system strikes the NAV on bank funds or private-labeled funds. Preferably, therefore, a fund accountant is retained in the back office in any country where funds are being managed. For example, there is preferably an office in Dublin and Luxembourg with fund accountants located there. Shareholder services (level 1) are also provided in the countries where customer interfacing takes place. In the preferred embodiment, shareholder services are provided in Dublin and Luxembourg. Also, preferably a Relationship Manager/Account Manager is provided who is the client servicing person.

Pooling Technology Infrastructure

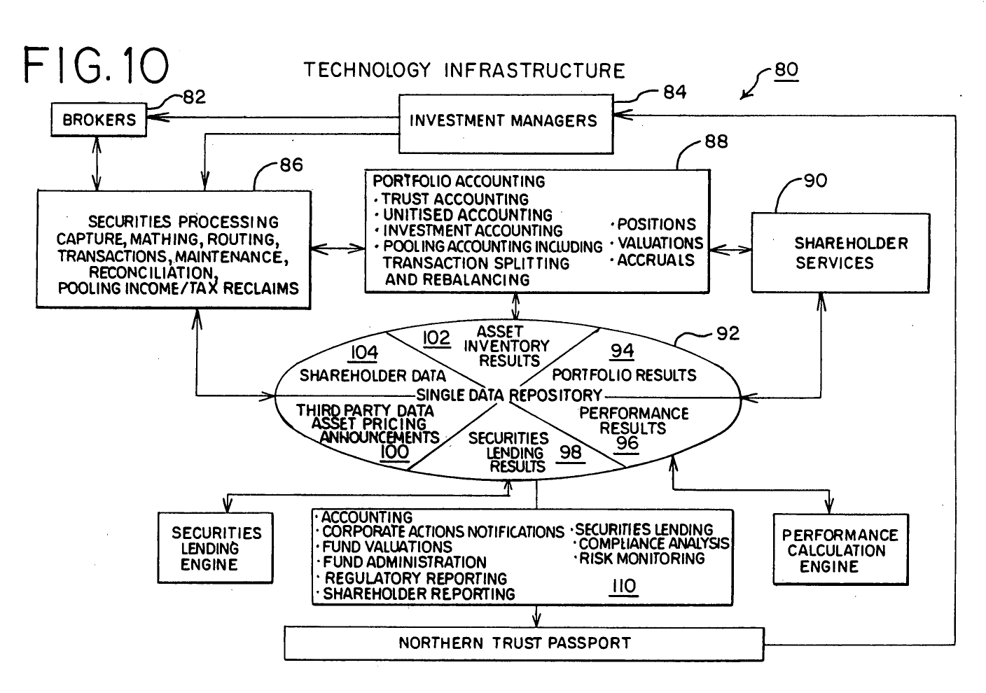

Turning now to FIG. 10, a block diagram of the presently preferred technology system infrastructure used to support the cross-border pooling system and process is shown. The infrastructure 80 shown in FIG. 10 is typical for most fund accounting clients today, but includes amendments that are specific to the pooling invention. As shown in FIG. 10, the brokers 82 and the investment managers 84 trade securities back and forth as per usual. From there, all trades will capture down to the securities processing module 86, or the money will flow back to the brokers 82 for further trades. The fund management system of the invention captures the information from securities processing and brings it into the portfolio accounting system 88 shown in FIG. 10.

The shareholder services box 90 receives information from various data sources. The circle 92 in the middle of FIG. 10 represents all functions that can be provided in addition to the accounting function on the preferred system. The system preferably can calculate and account for portfolio results 94; performance results 96; securities lending 98; third-party data 100, like asset set-up, pricing, etc.; corporate actions or announcements 102; and shareholder data 104. The information that comes out of the system goes into a normal banking account system 110. So, if you're a customer of a banking institution, for example, you can log into your account, and preferably see all your investment data including that information associated with your cross-border pooling funds. Investment managers preferably have the capability to access account information via the Web as well.

The major differences in FIG. 10 that reflect the operations of the pooling system and process described herein are the trade splitting and rebalancing accounting processes shown in portfolio accounting 88, and the tax/income processing and tax reclaim shown in the securities processing 86. The portfolio accounting box 88 is different because it takes into account the trade splitting and the rebalancing, which are the features of pooling that are different from typical accounting. Securities processing 86 box is different because income is broken out per investor at level 4 in individual income accounts 38. For each account captured, the system processes its tax reclaim or its income collection just as if it was an individual account today. So it is income processing on custody that is different for a pooling environment, and tax reclaim which is part of income processing.

Pooling Fund Accounting Flow Chart

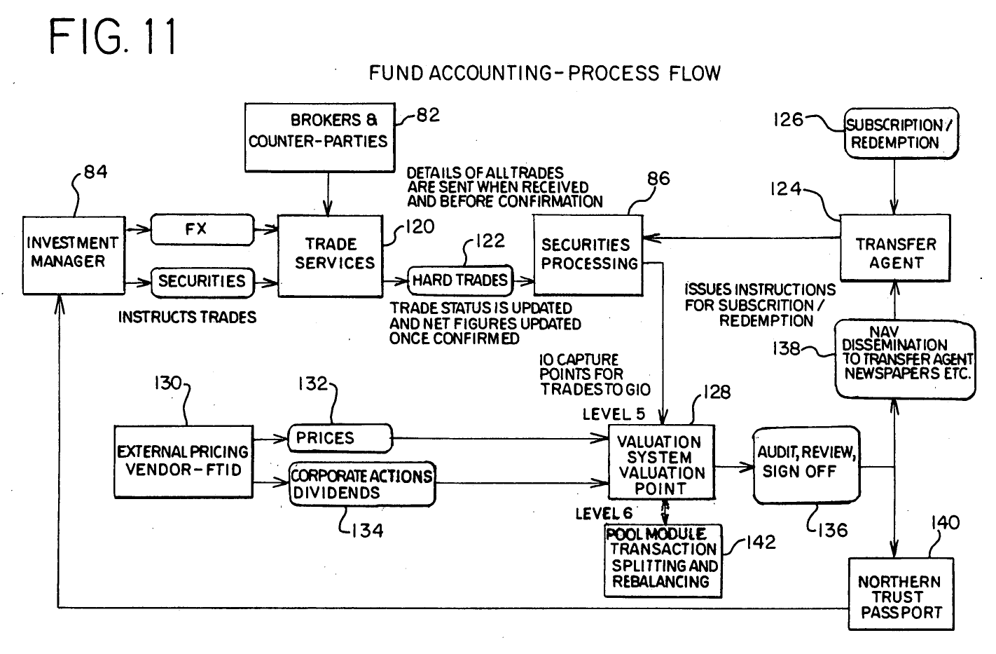

Referring now to FIG. 11, a flow chart for the fund accounting process of the invention is shown. As illustrated, the brokers 82 give all of their trades to trade services 120. It's all done through the standard SWIFT communication vehicle, which uses standard file formats. For example, a purchase file format, sale file format, etc. are used. This information is communicated to trade services 120, and the hard trades 122 go into the securities processing box 86in FIG. 11. Hard trades are what come into a pooling environment (soft trades are not allowed in the preferred embodiment). In addition, subscriptions and redemptions 126 flow through the transfer agent box 124 into the securities processing box 86 as shown. From securities processing 86 the data goes into the valuation system 128, which in the preferred embodiment uses the GIO software described above.

The external pricing vendors 130, shown in the left bottom of FIG. 11, provide data on prices 132, and corporate actions and dividends 134 that come in to the GIO software represented in the valuation system box 128. From there, the system audits the data, a review and sign off are performed 136, and then the NAV dissemination 138 goes out through normal banking account services 140 to the customers. Preferably, this data also goes up to the transfer agent 124. In the context of the above discussion about fund accounting and transfer agents, FIG. 11 provides an overview of where each function falls into the overall process. The essential difference provided in FIG. 11 for pooling, compared to normal fund accounting, is the pooling module box 142. This box 142 represents the additional transaction splitting and rebalancing functions described above that are provided at level 6, which have been broken out of the valuation box 128 for clarity and emphasis.

Table 1 below provides definitions for some of the terms and acronyms used in the above discussion:

TABLE 1
DEFINITIONS OF TERMS USED

| TERM | DEFINITION |
|---|---|
| FCP | Fonds Commun de Placement - Luxembourg tax- |
| | transparent vehicle. |
| CCF | Common Contractual Fund - Irish tax- |
| | transparent vehicle. |
| FGR | Fonds voor Gemene Rekening - Dutch tax- |
| | transparent vehicle. |
| Dealing Day | The day that subscriptions, redemptions, and |
| | reinvestment of income are processed. In the |
| | preferred embodiment, there are two dealing |
| | days per month, typically the first and 15^{th} |
| | day of the month. Any shareholder activity |
| | processed on dealing day triggers a new |
| | calculation of percentage ownership. |
| Dealing | Dealing Day to Valuation Day. Typically, |
| Period | there are two dealing periods per month. |
| Investment | Any one or more persons or corporations |
| Manager | appointed by the Manager in accordance with |
| | the requirements of the Authority to manage |
| | the investment and re-investment of some or |
| | all of the assets of any one or more of the |
| | Portfolios of the Fund. |
| Manager | Company approved by the regulator as manager |
| | of the Fund (i.e. Management Company). |
| Portfolios | A fund of assets established for each portfolio |
| | of the Fund, which is invested in accordance |
| | with the investment objectives applicable to |
| | such portfolio. |
| Transferable | Shares in companies and other securities |
| Securities | equivalent to shares in companies, bonds and |
| | other forms of securitized debt, any other |
| | negotiable securities which carry the right |
| | to acquire any such transferable securities |
| | by subscription or exchange, excluding the |
| | techniques and instruments referred to in |
| | section 48A of the Regulations. |
| TA | Transfer Agent (also known as Shareholder |
| | Services): Responsible for maintaining records |
| | of each inventor's transactional activity |
| | (subscriptions, redemptions, and dividend |
| | reinvestments) and ownership (unit holdings). |
| NAV Day | The “as of” day the Net Asset Value (NAV) |
| | is struck and income is distributed (if the |
| | fund is set up to distribute income.) Occurs |
| | the day before Dealing Day. |
| Share Class | Typically, a share class equates to the |
| (Pooling) | different country plans or investors (tax |
| | treaties) participating in the funds. For |
| | example, each country plan or investor will |
| | have its own “share class” that reflects |
| | its unique income earned as a result of its |
| | tax treaties; therefore, a fund with 4 country |
| | plans investing in it will have 4 share classes. |
| Income | Custody account set up for each investor per |
| Account | investment manager per sub-fund to allocate |
| (Level 4) | and receive income entitlements and outstanding |
| | tax reclaims. This account does not hold securities. |
| Master | Custody account set up for each investment |
| Account | manager that records all investment related |
| (Level 4) | activity. |
| Omni | Accounting account set up for each investment |
| Account | manager that represents all activity. This |
| (Level 5) | account combines all custody activity from |
| | related Income and Master accounts for a given |
| | investment manager. |
| Investor | The investor specific accounting account set |
| Account | up for each investment manager per sub-fund to |
| (Level 6) | provide investor accounting. The account actually |
| | holds the securities in the same percentage |
| | portion as the investor's (or country plan's) |
| | ownership of the fund. The investor's unique |
| | income entitlements are also included. |

It is to be appreciated that a wide range of changes and modifications to the above examples of the best modes for carrying out the invention are contemplated without departing from the essential spirit and scope of the invention. It is therefore intended that the foregoing detailed description be regarded as illustrative rather than limiting, and that it be understood that it is the following claims, including all equivalents, that are intended to define the spirit and scope of this invention.

We claim:

1. A data processing system for managing a financial services configuration of a portfolio established as a pool of funds, comprising:
a managed fund, the managed fund having legal ownership of all assets within the fund;
at least one account (a subset of the managed fund) reflecting the asset ownership proportions in the managed fund, the at least one account not having legal ownership of any independent financial assets, but owning a percentage share in all the assets of the managed fund; and
means for reporting of distributed and rebalanced funds to ensure that the at least one account maintains a proportionate share of the assets within the managed fund.

2. The data processing system of claim 1, wherein the managed fund comprises a collective investment vehicle.

3. The data processing system of claim 1, wherein the assets owned by the managed fund are pooled to enhance investment efficiency.

4. The data processing system of claim 1, wherein the at least one account reflects the ownership interest of at least one investor.

5. The data processing system of claim 1, wherein a consolidation of the at least one account reflects one hundred percent of the managed fund.

6. The data processing system of claim 1, wherein the at least one account comprises a plurality of accounts, each account owning a percentage share of the managed fund.

7. The data processing system of claim 6, further comprising means for transferring ownership interest among the plurality of accounts as a result of transactions within the managed fund.

8. The data processing system of claim 6, further comprising means of transferring ownership interest between the plurality of accounts as a result of changes in the percentage ownership of investors in the managed account.

9. The data processing system of claim 8, wherein the means for transferring transfers ownership interest in the managed fund to maintain proportionate ownership of each of the plurality of accounts of the managed fund both before and after distributing and rebalancing of funds.

10. A method for managing a financial services configuration of a portfolio established as a pool of funds, comprising:
providing a managed fund, the managed fund having legal ownership of all assets within the fund;
forming at least one account, the at least one account not having legal ownership of any independent financial assets, but owning a percentage share of the managed fund; and
ensuring that the at least one account maintains a proportionate share of assets within the managed fund.

11. The method for managing a financial services configuration defined of claim 10, further comprising transferring ownership interest between and among the at least one account by distributing and rebalancing of funds.

12. The method for managing a financial services configuration defined of claim 10, further comprising transferring ownership interest of the managed fund to maintain the same proportionate ownership of the at least one account in the managed fund both before and after distributing and rebalancing of funds.

13. A fund management system for providing tax transparency to separate investors across country boundaries, comprising:
a managed fund for owning at least one security, the managed fund being open to investment by a plurality of investors who can purchase a percentage ownership in the managed fund; and
an account that reflects rights in the managed fund and thus mirrors the asset ownership proportions in the managed fund to maintain a relative percentage ownership of each of the plurality of investors in response to changes in the at least one security in the managed fund.

14. The fund management system defined in claim 13, wherein changes in the at least one security comprise purchase of a security.

15. The fund management system defined in claim 13, wherein changes in the at least one security comprise redemption of a security.

16. The fund management system defined in claim 13, wherein changes in the at least one security comprise income from a security.

17. The fund management system defined in claim 13, wherein changes in the at least one security comprise losses from a security.

18. The fund management system defined in claim 13, wherein the plurality of investors each own a percentage ownership in the managed fund.

19. The fund management system defined in claim 13, wherein the plurality of investors can sell a percentage ownership in the managed fund.

20. The fund management system defined in claim 13, wherein the at least one security comprises an equity position.

21. The fund management system defined in claim 13, wherein the at least one security comprises a debt position.

22. The fund management system defined in claim 13, wherein the at least one security comprises a derivative position.

23. The fund management system defined in claim 13, wherein the managed fund comprises a plurality of managed funds.

24. The fund management system defined in claim 13, wherein the plurality of investors comprises at least one pension fund.

25. The fund management system defined in claim 13, wherein the plurality of investors comprises at least one insurance fund.

26. The fund management system defined in claim 13, wherein the plurality of investors comprises at least one investment fund.

27. The fund management system defined in claim 13, wherein the plurality of investors comprises at least one endowment.

28. The fund management system defined in claim 13, wherein the account representing proportionate shares of the managed fund comprises owning an interest in the at least one security owned by the managed fund.

29. The fund management system defined in claim 13, wherein the at least one security comprises a plurality of securities.

30. The fund management system defined in claim 13, further comprising means for segregating income from capital.

31. The fund management system defined in claim 30, wherein the income can be taxed separately and according to a plurality of tax treaties.

32. The fund management system defined in claim 13, wherein the plurality of investors reside in a plurality of countries.

33. The fund management system defined in claim 23, wherein the plurality of managed funds exists in a plurality of countries.

34. A method for managing an investment fund to provide tax transparency to separate investors across country boundaries, comprising:
providing a managed fund, for owning at least one security, the managed fund being open to investment by a plurality of investors who can purchase a percentage ownership in the managed fund; and
providing an account that reflects rights in the managed fund and thus mirrors the asset ownership proportions in the managed fund to maintain a relative percentage ownership of each of the plurality of investors in response to changes in the at least one security in the managed fund.

35. The method for managing an investment fund defined in claim 34, wherein changes in the at least one security comprise purchasing a security.

36. The method for managing an investment fund defined in claim 34, wherein changes in the at least one security comprise redeeming a security.

37. The method for managing an investment fund defined in claim 34, wherein changes in the at least one security comprise receiving income from a security.

38. The method for managing an investment fund defined in claim 34, wherein changes in the at least one security comprise receiving losses from a security.

39. The method for managing an investment fund defined in claim 34, further comprising owning a percentage ownership in the managed fund.

40. The method for managing an investment fund defined in claim 34, further comprising selling a percentage ownership in the managed fund.

41. The method for managing an investment fund defined in claim 34, wherein the account represents a proportionate share of the managed fund by owning an interest in the at least one security owned by the managed fund.

42. The method for managing an investment fund defined in claim 34, wherein maintaining a relative percentage ownership further comprises segregating income from capital.

43. The method for managing an investment fund defined in claim 42, further comprising paying taxes on the income separately and according to a plurality of tax treaties.
